(19) United States
(12) Patent Application Publication
(10) Pub. No.: US 2006/0025088 A1
(43) Pub. Date: Feb. 2, 2006

(54) Device for dynamic impedance matching between a power amplifier and an antenna

(76) Inventors: Rainer Pietig, Aachen (DE); Rainer Kiewitt, Roetgen (DE); Marion Kornelia Matters-Kammerer, Limbricht (DE); Thomas Purr, Munchen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/521,720

(22) PCT Filed: Jul. 11, 2003
(86) PCT No.: PCT/IB03/03175

§ 371 Date: Jul. 25, 2005

(30) Foreign Application Priority Data
Jul. 20, 2002 (DE) 102331235

(51) Int. Cl. H04B 1/04; H01Q 11/12

(52) U.S. Cl. 455/121

(57) ABSTRACT

A device for dynamic impedance matching between a power amplifier and an antenna, having a circulator (210), which routes a signal received from the power amplifier (10) at a first port via a second port to the antenna (30) and diverts the signal reflected at the antenna (30) and received at the second port through a third port; and a controllable matching network (24, 240, 250); is characterized in that a directional coupler (200) diverts a proportion of the signal traveling from the power amplifier (10) to the antenna (30), from which the magnitude and phase of the signal may be derived, to a signal detector (220); and the circulator (210) routes the entire signal reflected at the antenna (30) into the signal detector (220); wherein the signal detector (220) passes the magnitude and phase of both the signal traveling to the antenna (30) and the signal reflected at the antenna (30) to a controller (230), which evaluates the information received from the signal detector (220) in order to determine the present impedance value of the antenna (30) and to correct the controllable matching network (24, 240, 250) having active and passive components in accordance with the determined impedance value of the antenna (30).

The invention relates to a device for dynamic impedance matching between a power amplifier and an antenna, having a circulator, which routes a signal received from the power amplifier at a first port via a second port to the antenna and diverts the signal reflected at the antenna and received at the second port through a third port, and a matching network.

Wireless radio networking is a key technology of the telecommunications industry, the significance of which will increase further in the next few years through the introduction of the UMTS (Universal Mobile Telecommunications/Telephony System) standard. This standard will initially exist in parallel with the old GSM (Global System for Mobile Communications) standard and will only gradually displace it, if at all. The first UMTS-capable cell phones, also known as third generation devices, will therefore as a rule be GSM-capable, and consequently will contain two more or less independent radio systems. The requirements of the electronic components used therein with regard to degree of miniaturization and quality of the electrical properties will increase accordingly, since only a few components of the two radio systems can be used simultaneously.

To ensure the functionality of a UMTS network, it is essential for subscribers' cell phones to be able to effect intelligent adjustment of transmitter power. The basis for this lies in the modulation or access procedure used, namely wideband CDMA (Code Division Multiple Access). In contrast to GSM, the subscribers are not assigned any radio channels of their own, but rather each subscriber uses the full frequency band. In order nonetheless to be able to distinguish between the signals of the different subscribers, a code is assigned to each, which both the subscriber and the base station use for modulation. In order for two different subscribers not to disturb one another, only so-called orthogonal codes ought to be used, but only a small number of these are available. Therefore, non-orthogonal codes are also used in each UMTS network. However, the base station has then to be in a position to adjust downwards the transmitter power of an interferer. This transmitter power controllability is the only way in which the UMTS network can function in a problem-free manner.

The GSM standard also allows for the downwards adjustment of the subscriber's transmitter power, but only in the case of good base station reception. Transmitter power adjustment therefore serves only to increase cell phone talk time.

However, the latter is vastly more important for UMTS devices than it is for GSM devices. Since the wideband CDMA method does not operate with time slots during which transmission or reception may take place, but instead the receivers are constantly ready to receive and transmission and reception proceed simultaneously, the energy consumption of UMTS devices is greater. To ensure long standby and talk times, battery power has to be used economically.

One part of the radio frequency circuit which is important for power management is the so-called matching network between the output of the radio frequency amplifier and the antenna. It ensures that the output impedance of said power amplifier is matched to the input impedance of the antenna. Such matching is necessary, since otherwise some of the power is reflected at the antenna input back onto the output of the power amplifier. Some of the power is then no longer available as transmitter power. If the proportion of backscattered power is too great, oscillations may additionally arise due to feedback, such that the radio connection ultimately breaks. The input impedance of the antenna of a cell phone is not a fixed value, but rather depends to a considerable extent on the surroundings thereof, for example even on how the user holds the cell phone. In the case of static impedance matching, as is the norm in existing devices, a not inconsiderable part of the power is therefore always reflected at the antenna input and is thus lost as transmitter power.

Static impedance matching is performed, for example according to EP 1 076 374 A2, by providing a matching network having passive components, such as capacitors, wherein a circulator allows access to various parts of the matching network.

A further device for impedance matching between a power amplifier and an antenna is known from EP 0 741 463 A2. It is characterized, in particular, in that a circulator ultimately releases the signal reflected by the antenna for dissipation. Dynamic matching does not occur here either.

It is therefore an object of the invention to provide a device for dynamic impedance matching between a power amplifier and an antenna, as described above, which is in a position to adapt automatically to the instantaneous antenna impedance. This object is achieved by a device as claimed in claim 1. Advantageous developments constitute the subject matter of the dependent claims.

The invention is characterized in that a directional coupler diverts a proportion of the signal traveling from the power amplifier to the antenna, from which the magnitude and phase of the signal may be derived, to a signal detector and the circulator routes the entire signal reflected at the antenna into the signal detector, wherein the signal detector passes the magnitude and phase of both the signal traveling to the antenna and the signal reflected at the antenna to a controller, which evaluates the information received from the signal detector in order to determine the present impedance value of the antenna and to correct the controllable matching network containing active and passive components in accordance with the determined impedance value of the antenna. A controller should be understood to mean a microcontroller conventionally used in semiconductor circuits.

According to the invention, both the signal traveling from the power amplifier to the antenna and the signal reflected at the antenna by mismatch are measured. Measurement of the signal traveling to the antenna is effected by means of a directional coupler, which diverts a small proportion of the power. The diverted signal may then subsequently be detected. Such detection is usually used to control the output power of the power amplifier. The problem hitherto has been with measurement of the reflected signal, which is usually much weaker than the signal traveling to the antenna; If only one directional coupler were used, therefore, only a very weak signal would be available for detection, such that complex and expensive electronics would be necessary. Such a solution would not be feasible at all in the case of cell phones. Use according to the invention of the circulator circumvents these expensive electronics. The circulator ensures that the complete signal is available for detection, of the returning signal, such that very cheap electronics may be used. Furthermore, the power amplifier is protected from the returning signal. The stability and linearity of the power amplifier are improved decisively thereby.

At least the directional coupler, the circulator, the signal detector and the controller or micro-controller are preferably arranged immediately downstream of the power amplifier.

According to one development of the invention, the controllable matching network is arranged immediately upstream of the antenna and connected via a control line to the components for signal detection and control. This configuration has the advantage that the receive branch is automatically also matched.

According to a similarly preferred embodiment, the directional coupler, the circulator, the signal detector and the controller together with the controllable matching network take the form of a module and are arranged immediately downstream of the power amplifier.

The active components of the controllable matching network may comprise varactor diodes, MEM switches and the like.

The device according to the invention may be used in conjunction with LTCC (“Low Temperature Cofire Ceramics”) technology, by integrating the directional coupler, the circulator and the passive components of the controllable matching network into an LTCC substrate using ferrite material.

The signal detector, the controller and the active components of the controllable matching network may be integrated into a semiconductor chip.

The device according to the invention for dynamic impedance matching is used in a communications apparatus, in particular a cell phone. It substantially improves the efficiency of the cell phone and stabilizes the power amplifier contained therein.

Finally, the invention also defines a method for dynamic impedance matching between a power amplifier and an antenna, characterized in that the magnitude and phase of both the signal traveling to the antenna and the entire signal reflected at the antenna are evaluated, in order to determine the present impedance value of the antenna, and a controllable matching network comprising active and passive components is corrected in accordance with the determined impedance value of the antenna.

The invention will be further described with reference to examples of embodiments shown in the drawings to which, however, the invention is not restricted. In the Figures:

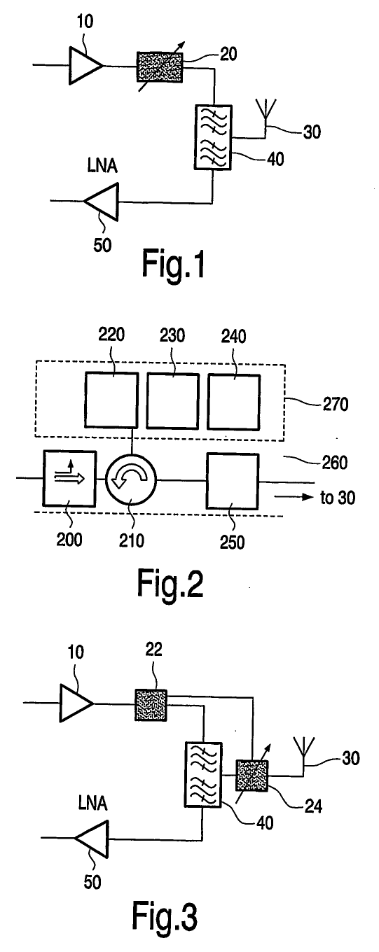

FIG. 1 is a schematic diagram of the radio frequency front-end of a cell phone with a modular device for dynamic impedance matching between power amplifier and antenna according to the present invention;

FIG. 2 is a block diagram of the module of FIG. 1; and

FIG. 3 is a diagram similar to FIG. 1, but in which the device according to the invention takes the form of two sub-modules.

FIG. 1 is a schematic view of the radio frequency front-end of a cell phone, in which a signal leaving a power amplifier 10 is routed through a module 20, which effects dynamic impedance matching and will be described more fully with reference to FIG. 2, before it passes through a duplex filter 40 to reach an antenna 30. For the sake of completeness, the signal path for a signal picked up from the antenna 30 is also shown, which signal is in turn routed through the duplex filter 40 to an LNA amplifier 50 (low noise amplifier). The module 20 ensures on the one hand that the antenna 30 is optimally matched to the power amplifier 10, such that normally the total output power of the power amplifier 10 is available as transmitter power. On the other hand, the power amplifier 10 is protected from any backscattered power, which may arise for instance in the case of drastic impedance variations at the antenna 30, which lie outside the control range of the module 20. The module 20 thus additionally fulfills the function of an isolator.

The combination of these properties is achieved with a construction as illustrated as a block diagram in FIG. 2. A directional coupler 200 diverts a proportion of the signal traveling to the antenna 30 and supplies it to a signal detector 220 for evaluation. The non-diverted main portion of the signal travels through a circulator 210 and passive components 250 of the matching network to the antenna (not shown in FIG. 2). The circulator 210 additionally ensures that the entire signal reflected at the antenna likewise reaches the signal detector 220. The signal detector 220 passes on the magnitude and phase both of the power traveling to the antenna and of the reflected power via a control line to a microcontroller 230. This evaluates the information and appropriately corrects the matching of the active components 240, which, together with the passive components 250, form the controllable matching network. Varactor diodes may be used as controllable capacitors; the use of MEM switches (microelectromechanical switches) is also possible. The directional coupler 200, the circulator 210 and the passive, i.e. non-controllable, components 250, of the controllable matching network are integrated into an LTCC substrate 260. A semiconductor chip 270, which contains the detector 220, the microcontroller 230 and the active components 240 of the controllable matching network, is located on the substrate 260.

The essential feature of the invention is use of the circulator in the manner described. Otherwise, there are various possible ways of varying the structure of the device.

An example of this is illustrated in FIG. 3. A sub-module 22 comprises the circulator, the directional coupler, the signal detector and the microcontroller, in the arrangement as also shown in FIG. 2. The sub-module 22 is located directly at the output of the power amplifier 10. The matching network with the active and passive components is fitted as a second sub-module 24 immediately upstream of the antenna 30. This configuration has the advantage that the receive branch is matched at the same time as the transmit branch. Dynamic matching of the receive branch is only possible in this way, since the received signal is itself very weak and direct detection would thus require complex, expensive electronics.

1. A device for dynamic impedance matching between a power amplifier and an antenna, having a circulator (210), which routes a signal received from the power amplifier (10) at a first port via a second port to the antenna (30) and diverts the signal reflected at the antenna (30) and received at the second port through a third port; and
a matching network (24, 240, 250);
characterized in that a directional coupler (200) diverts a proportion of the signal traveling from the power amplifier (10) to the antenna (30), from which the magnitude and phase of the signal may be derived, to a signal detector (220); and
the circulator (210) routes the entire signal reflected at the antenna (30) into the signal detector (220);
wherein the signal detector (220) passes the magnitude and phase of both the signal traveling to the antenna (30) and the signal reflected at the antenna (30) to a controller (230), which evaluates the information received from the signal detector (220) in order to determine the present impedance value of the antenna (30) and to correct the controllable matching network (24, 240, 250) containing active and passive components in accordance with the determined impedance value of the antenna (30).

2. A device as claimed in claim 1, characterized in that at least the directional coupler (200), the circulator (210), the signal detector (220) and the controller (230) are arranged immediately downstream of the power amplifier (10).

3. A device as claimed in claim 1 or 2, characterized in that the controllable matching network (24) is arranged immediately upstream of the antenna (30).

4. A device as claimed in claim 1 or 2, characterized in that the directional coupler (200), the circulator (210), the signal detector (220) and the controller together with the controllable matching network (240, 250) take the form of a module (20) and are arranged immediately downstream of the power amplifier (10).

5. A device as claimed in any one of claims 1 to 4, characterized in that the active components (240) of the controllable matching network comprise varactor diodes, MEM switches and the like.

6. A device as claimed in any one of claims 1 to 5, characterized in that the directional coupler (200), the circulator (210) and the passive components (250) of the controllable matching network are integrated into an LTCC substrate (260).

7. A device as claimed in any one of claims 1 to 6, characterized in that the signal detector (220), the controller (230) and the active components (240) of the controllable matching network are integrated into a semiconductor chip (270).

8. A communications apparatus, in particular a cell phone, having a device for dynamic impedance matching between a power amplifier and an antenna as claimed in any one of claims 1 to 7.

9. A method for dynamic impedance matching between a power amplifier and an antenna,
characterized in that the magnitude and phase of both the signal traveling to the antenna (30) and the entire signal reflected at the antenna (30) are evaluated, in order to determine the present impedance value of the antenna (30); and
a controllable matching network (24, 240, 250) having active and passive components is corrected in accordance with the determined impedance value of the antenna (30).
